(19) United States
(12) Patent Application Publication
(10) Pub. No.: US 2004/0265625 A1
(43) Pub. Date: Dec. 30, 2004

(54) OLED sample or electron microscope examination and method for making the same

(75) Inventor: He-Ting Tsai, Tainan City (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 10/759,128

(22) Filed: Jan. 20, 2004

(30) Foreign Application Priority Data
Jun. 24, 2003 (TW) 92117136

(51) Int. Cl. H05B 33/12

(52) U.S. Cl. 428/690; 428/917; 428/332; 313/504; 427/66

(57) ABSTRACT

An OLED sample for electron microscope examination sequentially includes a substrate, a first electrode, an organic layer, a second electrode, and a protecting layer. By providing electron beams to strike the OLED sample and by controlling the thickness of the OLED sample within 0.2 μm to 0.3 μm, the opportunity that molecules of the organic layer can be stroked by the electron beam can be increased so as to obtain a clear image of the OLED sample.

### BACKGROUND OF THE INVENTION

(1) Field of the Invention

The invention relates to a sample for electron microscope examination, and more particularly to a sample of organic light emitting diode (OLED) for transmission electron microscope examination and, also, to a method for making the OLED samples.

(2) Description of the Prior Art

A thorough understanding upon material's microstructure is essential while in improving the performance of existing materials or in developing new materials for innovative applications. A variety of instruments are already available in the marketplace for microstructure characterization. In the art, the electron microscope (EM), one of major instruments for characterizing material's microstructure, uses a focused beam of electrons instead of light to “image” the material sample and grasp information about material's structure, compositions, chemical bonding, electron distribution and so on.

It is well known that the electron microscope is introduced to release the limitations of traditional light microscopes whose performance are limited by the physics of light to 500× or 1000× magnifications and to a minimum resolution of 0.2 micrometers. The electron microscope can use a beam of highly energetic electrons to examine objects to an extremely fine scale. The examination of electron microscopes can yield lots of information such as topography, morphology, compositions and crystallographic data, etc. Two most common types of electron microscopes available commercially are the transmission electron microscope (TEM) and the scanning electron microscope (SEM). The TEM examines a sample by sending an electron beam through the sample to reveal detail internal structure of the sample. In EM's application, sample preparation is important. A satisfied preparation of samples in any microscopical technique can facilitate the examination and thus can further help following interpretation upon microstructural features of the sample material. On the other hand, improper sample preparation may obscure the realization upon material's features, and may even lead to mis-interpretation of the material.

Referring to FIG. 1, a typical organic light emitting diode (OLED) device generally includes stacking layers starting with a light transmissive anode 14 formed on the transparent substrate 16, an organic electroluminescent (EL) emission medium 10 deposited over the light transmissive anode 14, and a metal cathode 12 on top of the organic electroluminescent emission medium 10. In particular, the organic electroluminescent emission medium 10 further includes an electron-transport layer 101, a light emitting layer 102, and a hole-transport layer 103. When an electrical potential is placed across the metal cathode 12 and the light transmissive anode 14, holes and electrons can then be injected into the organic zones from the anode 14 and cathode 12, respectively. In this device, light emission is a definite result of hole-electron recombination within the device. Conventionally, thickness of each isolated layer within the organic electroluminescent (EL) emission medium 10 can be only provided by the in-situ crystal oscillator, not by any practical measurement. Therefore, less effort can be really applied to detect and control the thickness of any particular layer within the organic material.

In order to examine the inner structure of the organic electroluminescent (EL) emission medium 10, the TEM is usually utilized. By using a focus ion beam (FIB), the sample preparation can be made thinner down to less 0.1 micrometers. Basically, the thinner the sample is, the clearer the resolution of the sample image is. As shown in FIG. 2, for an OLED sample with a thickness less than 0.1 mm prepared by traditional skill, the inner structure and arrangement of the organic electroluminescent (EL) emission medium 10 can not be clearly realized by means of a TEM. To have a better examination result, it is always inevitable to make the examined sample as thinner as possible. Yet, empirically, the inner structure and arrangement of the organic electroluminescent (EL) emission medium 10 are still way to be clear by only making thinner the sample. Therefore, effort of the present invention to provide a TEM sample preparation method for OLED device so as to clearer realize the inner structure and the layer arrangement of the organic material is definitely welcome by the skilled in the art.

### SUMMARY OF THE INVENTION

Accordingly, it is a primary object of the present invention to provide a sample for electron microscopes examination by which the inner structure and arrangement of an organic material, particularly an OLED material, can be better realized

It is another object of the present invention to provide a preparation method for producing the OLED sample for electron microscopes examination.

In the present invention, an OLED sample for electron microscope (e.g. TEM) examination sequentially includes a substrate, a first electrode, an organic layer, a second electrode, and a protecting layer (e.g. Pt, W, etc.). In the method for producing the OLED sample, an electron beam can be emitted from an electron microscope to strike an OLED sample and make it to a thickness within 0.2 μm to 0.3 μm so that the opportunity of striking right at molecules of the organic layer can be increased and thus a clear diffraction image of the OLED sample can be obtained.

In the present invention, the method to prepare an OLED sample for electron microscope examination can comprise following steps. Firstly, an OLED device which includes sequentially a substrate, a first electrode, an organic layer, a second electrode is provided. Next, a protecting layer over a surface of the OLED device is formed. Finally, a milling procedure over the OLED device is performed to obtain a thin film of the OLED sample.

### BRIEF DESCRIPTION OF THE DRAWINGS

The present invention will now be specified with reference to its preferred embodiment illustrated in the drawings, in which

FIG. 1 is a schematic view of an OLED structure;

FIG. 2 is a schematic cross-section view of an OLED sample prepared by traditional skill and examined by a TEM;

FIG. 3 is a flowchart of a preferred method for preparing an OLED sample according to the present invention;

FIG. 4 is a schematic top view of the OLED device after proceeding the milling procedures of FIG. 3; and

FIG. 5 is a schematic cross-section view of the OLED sample examined by TEM according to the preferred method of the present invention shown in FIG. 3.

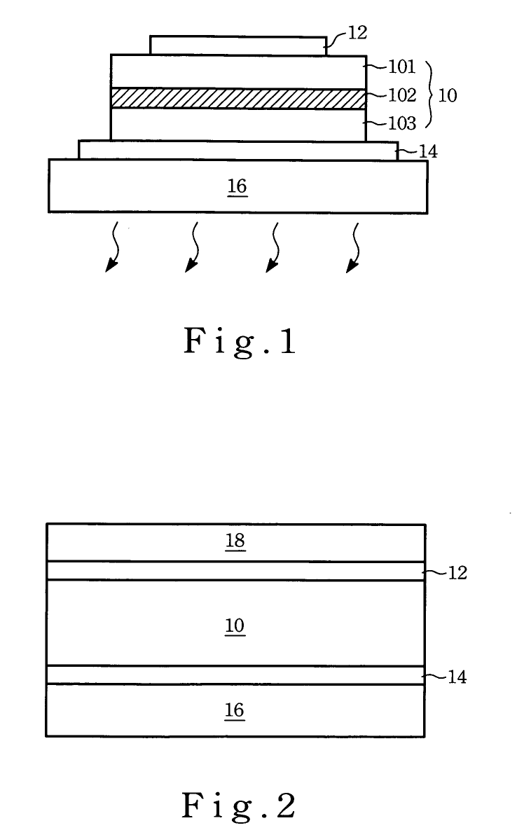

### DESCRIPTION OF THE PREFERRED EMBODIMENT

The invention disclosed herein is a sample for electron microscopes examination, and more particularly is a sample of organic light emitting diode (OLED) for transmission electron microscopes examination. Also, a method for making the sample of the present invention is introduced. In the present invention, by controlling thickness of the OLED sample, the transmitted and scattering electrons of the OLED can be examined and thereby a clear image of the OLED sample can be obtained. By providing the sample and the method of the present invention, the inner structure within the organic layer can be clearly identified by the electron microscopes. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

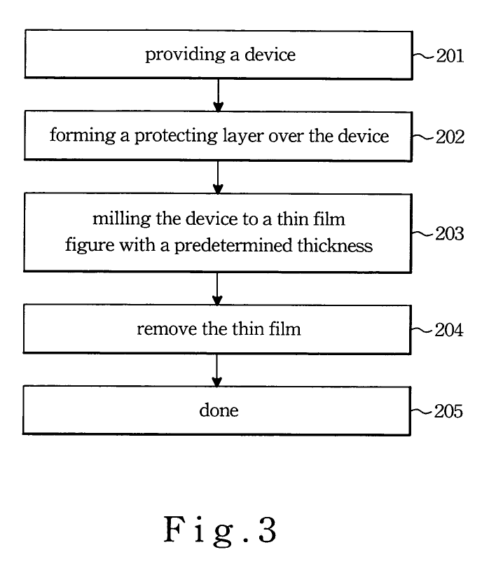

As shown in FIG. 3, a flowchart of a preferred method for preparing an OLED sample in accordance with the present invention is shown. In step 201, an OLED device is provided, in which the OLED device can sequentially include a substrate, a first electrode, an organic layer, and a second electrode. Besides, the organic layer can further include an electron-transport layer, a light emitting layer, and a hole-transport layer. However, slight difference in the aforementioned structure of the OLED device is usually seen and thus well known to the skilled person in the art and definitely any intent to include such difference shall be within the scope of this invention.

Immediately, in step 202, a protecting layer over a surface of the OLED device is formed. The material of the protecting layer can be chosen from a group of metals including platinum (Pt), tungsten (W), etc. In a preferred embodiment of the present invention, the protecting layer can be formed on a cross-section surface of the OLED device by applying a focus ion beam (FIB) technique. The thickness of the protecting layer is preferably about 2 micrometers to 3 micrometers. Upon such a protecting layer, various advantages can be obtained. One of those advantages is that the OLED device can be better protected and thus can have satisfied stability to avoid breakdown while proceeding the next milling procedure. Another is that the protecting layer can be used as a mark easy to be observed.

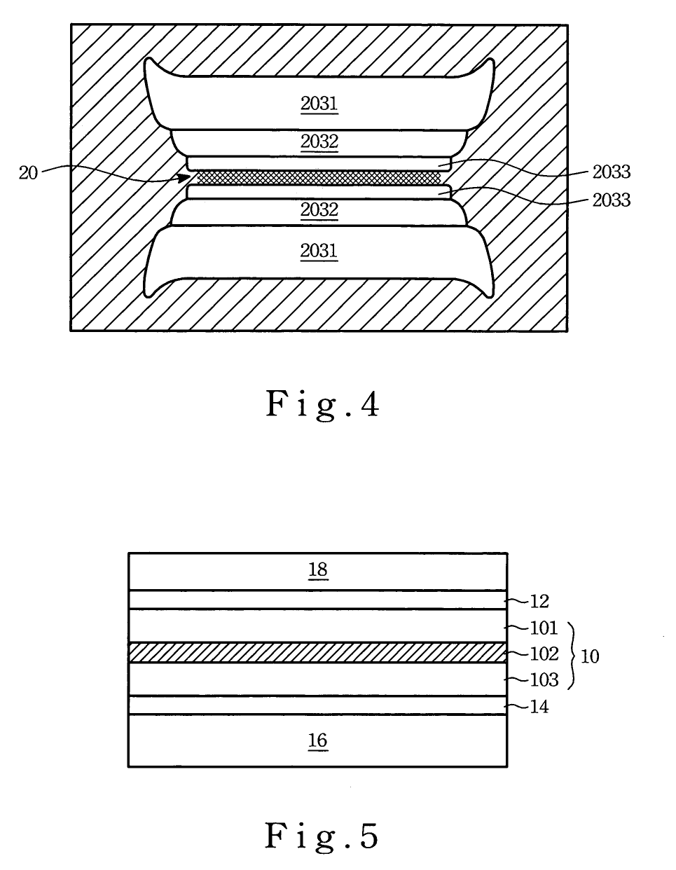

Subsequently, in step 203, milling the OLED device to a thin film with a predetermined thickness is performed. Meanwhile, referring also to FIG. 4, a schematic view of the OLED device after performing the milling procedure of FIG. 3 is illustrated. In this milling procedure, one side of the OLED device coated with a protecting layer is firstly chosen to sequentially perform a coarse milling, a intermediate milling, and a fine milling with the focus ion beam (FIB). Then, the other side of the OLED device is used to sequentially perform the same procedure with the same tool (FIB) till that a target thickness of the thin film of the OLED device between 0.2 micrometers to 0.3 micrometers can be obtained. As shown in FIG. 4, the holes 2031, 2032, 2033 are made by proceeding the coarse milling, the intermediate milling and the fine milling in turn.

In step 204, the thin film of the OLED device is then removed by cutting both sides of the thin film which may still connect with the original OLED device. Preferably, the aforesaid cutting can be executing by performing a focus ion beam (FIB). Finally, an OLED sample for transmission electron microscope (TEM) examination is obtained. While proceeding a cross-section sample examination, the first step is to put the OLED sample on a carbon film. Then, the carbon film with the OLED sample is placed on a mesh to further proceed sample examination by means of TEM.

Referring to FIG. 5, a schematic cross-section view of the OLED sample examined by TEM according to the present invention is illustrated. As shown, the organic layer 10 of the sample of the represent invention can be clearly identified into three layers, such as the electron-transport layer 101, the light emitting layer 102 and the hole-transport layer 103. This is because, by controlling the thickness of the OLED sample approximately within a predetermined range (0.2 μm to 0.3 μm), the opportunity of striking right at molecules of the organic layer 10 by transmitting electron beam can be increased, so that a clear inner structure image of the OLED sample can be obtained.

In summary, the preparation method of OLED sample for TEM examination in accordance with the present invention can provide at least following advantages over the conventional techniques:

1. By controlling the thickness of the OLED sample, the gradation within the organic layer can be clearly realized by a traditional TEM machine.

2. As long as the gradation within the organic layer is realized, the thickness of individual layer within the organic layer can be measured directly and uniquely.

3. In addition, because the illuminant layer of OLED device is highly related to the organic layer, so the control upon the thickness of individual layer within the organic layer can be used to optimize the illumination of the OLED device.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as will as other embodiments, are intended to be included within the scope of the appended claims. The invention is defined by the following claims, with equivalents of the claims to be included therein.

I claim:

1. A method to prepare an OLED sample for electron microscope examination, comprising steps of:
providing an OLED device including a substrate, a first electrode, an organic layer, and a second electrode, wherein said first electrode is located on said substrate, wherein said organic layer is located over said first electrode, wherein said second electrode is located over said organic layer;
forming a protecting layer over a surface of said OLED device; and
performing a milling procedure on said OLED device so as to obtain said OLED sample.

2. The method of claim 1, wherein a thickness of said OLED sample is within 0.2 μm to 0.3 μm.

3. The method of claim 1, wherein said milling procedure is performed by a focus ion beam (FIB).

4. The method of claim 1, wherein a thickness of said protecting layer is within 2 μm to 3 μm.

5. The method of claim 1, wherein said protecting layer is made of platinum (Pt).

6. The method of claim 1, wherein said protecting layer is made of tungsten (W).

7. The method of claim 1, wherein the step of performing a milling procedure further comprises a coarse milling process.

8. The method of claim 7, wherein the step of performing a milling procedure further comprises an intermediate milling process.

9. The method of claim 7, wherein the step of performing a milling procedure further comprises a fine milling process.

10. The method of claim 1, wherein said electron microscope is a transmission electron microscope (TEM).

11. An OLED sample for electron microscope examination, comprising:
a substrate;
a first electrode, formed on said substrate;
an organic layer, formed on said first electrode;
a second electrode, formed on said organic layer; and
a protecting layer, formed on said second electrode;
wherein a thickness of said OLED sample is controlled within 0.2 μm to 0.3 μm for increasing an opportunity that molecules of said organic layer are stroked by transmitting electron beam so as to obtain an image of said OLED sample.

12. The OLED sample according to claim 11, wherein said protecting layer is formed on said second electrode by using a focus ion beam (FIB) technique.

13. The OLED sample according to claim 11, wherein a thickness of said protecting layer is within 2 μm to 3 μm.

14. The OLED sample according to claim 1, wherein said protecting layer is made of platinum (Pt).

15. The OLED sample according to claim 1, wherein said protecting layer is made of tungsten (W).

16. The OLED sample according to claim 1, wherein said electron microscope is a transmission electron microscope (TEM).
